(19) United States
(12) Patent Application Publication
(10) Pub. No.: US 2024/0411277 A1
(43) Pub. Date: Dec. 12, 2024

(54) HYDROCARBON SYSTEM WITH AUTONOMOUS OPTIMIZING CONTROL

(71) Applicant: Sensia Netherlands B.V., Rotterdam (NL)

(72) Inventors: Jonathan Chong, Calgary (CA); Aquib Mustafa, Houston, TX (US); Albert Hoefel, Sugar Land, TX (US); Yasser El-Khazindar, London (GB)

(73) Assignee: Sensia Netherlands B.V., Rotterdam (NL)

(21) Appl. No.: 18/736,912

(22) Filed: Jun. 7, 2024

Related U.S. Application Data
(60) Provisional application No. 63/472,132, filed on Jun. 9, 2023.

(51) Int. Cl. G05B 13/02; E21B 33/03; E21B 43/12; G05B 13/04

(52) U.S. Cl. CPC G05B 13/0265; G05B 13/048; E21B 33/03; E21B 43/12; E21B 2200/20

(57) ABSTRACT

A method executable by one or more processors includes obtaining a measured value of a first variable at a current time step, estimating, with a first model, an estimated value of a second variable at the current time step based on the measured value of the first variable, generating, by a reinforcement learning model, a control decision for a subsequent time step based on the measured value of the first variable and the estimated value of the second variable, predicting, with a second model, a predicted value of the first variable for the subsequent time step based on the measured value of the first variable at the current time step, adjusting the control decision for the subsequent time step based on a constraint and the future value of the first variable, and controlling an actuator based on the control decision.

### CROSS-REFERENCE TO RELATED APPLICATION

This application claims priority to and the benefit of U.S. Provisional Patent Application No. 63/472,132, filed Jun. 9, 2023, the entire disclosure of which is incorporated by reference herein.

### BACKGROUND

The present disclosure relates to hydrocarbon sites. More specifically, the present disclosure relates to networks or control systems for hydrocarbon sites including but not limited to control systems using edge devices in industrial systems, such as gas and oil extraction stations.

### SUMMARY

One implementation of the present disclosure is a method executable by one or more processors. The method includes obtaining a measured value of a first variable at a current time step, estimating, with a first model, an estimated value of a second variable at the current time step based on the measured value of the first variable, generating, by a reinforcement learning model, a control decision for a subsequent time step based on the measured value of the first variable and the estimated value of the second variable, predicting, with a second model, a predicted value of the first variable for the subsequent time step based on the measured value of the first variable at the current time step, adjusting the control decision for the subsequent time step based on a constraint and the future value of the first variable, and controlling an actuator based on the control decision.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a field controller communicating with field equipment, input devices, and output devices, according to some embodiments.

FIG. 4 is an illustrations of a control system for a hydrocarbon system, according to some embodiments.

FIG. 5A is an illustration of another control system for hydrocarbon systems, according to some embodiments.

FIG. 5B is an illustration of another control system for hydrocarbon systems, according to some embodiments.

FIG. 5C is an illustration of a simulator, according to some embodiments.

FIG. 5D is an illustration of another simulator for hydrocarbon systems, according to some embodiments.

FIG. 6 is a block diagram of a control architecture for a hydrocarbon system, according to some embodiments.

FIG. 7 is a block diagram of a control architecture for a hydrocarbon system, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a hydrocarbon site may be operated, controlled, monitored, or served by a control system including various edge devices. The present disclosure relates generally to providing an autonomic, self-driving, and/or self-optimizing control system that executes strategic mission profiles defined by users, for example by utilizing intelligence packets deployed across a distributed control system in an efficient and scalable way. Approaches herein can minimize non-value-added dependency on human experts and maximize the combined human-system potential. The systems and methods herein can provide self-management of distributed computing resources and intelligence algorithms to adapt to unpredictable changes while hiding intrinsic complexity from operators and users. In some embodiments, the systems herein include networks of sensors, controllers, equipment, devices, etc. configured to measure variables (e.g., process variables, environmental conditions, machine operating conditions, etc.), automatically think (e.g., analyze using trained domain expertise), automatically control processes (e.g., by controlling equipment, actuators, devices, etc.), and continuously improve performance via optimization techniques. The teachings herein can provide progress towards zero operator systems, for example for applications in oil and gas equipment or other industrial equipment, for example for electric submersible pumps (ESPs), gas lift systems, chemical injection systems, etc.

Conventional process control techniques, including techniques involving some degree of predictive control or model-based operation, are well-suited for structured, relatively-static environments such as manufacturing line equipment. For other contexts, for example equipment deployed in dynamic environments which vary over time and for various deployments, conventional process control techniques may lack the adaptability required for reliable operations over time and for scalable deployment in a variety of environments, systems, use cases, etc., at least without significant human intervention to reprogram, reconfigure, retrain, build new models, etc. for each deployment and as conditions and dynamics change over time.

The present disclosure relates to systems and method advantageously configured for scalable, distributed deployment in environments such as oilfields with significant variability over time and across deployments. The systems and methods herein provide scalability (e.g., generality), e.g., the ability to be easily deployed in large numbers, in different physical locations, for different systems, etc. without substantial human reprogramming or other intervention. The systems and methods herein can also provide optimization over time, with continuous optimization and improvement providing high value for deployment in environments, processes, systems, different hydrocarbon sites, different wells, etc. which differ from one another and change dynamically over time. These advantages provide for efficient initial deployment and adaptation over time of systems and methods for control optimization and the like as described in further detail in the following passages.

The teachings herein can be implemented using features disclosed in U.S. Patent Application Publication No. 2022-0018231 published Jan. 20, 2022, U.S. Patent Application Publication No. 2022-0154889 published May 19, 2022, U.S. Patent Application Publication No. 2022-0180019 published Jun. 9, 2022, and/or U.S. Patent Application Publication No. 2022-0170353 published Jun. 2, 2022, the entire disclosures of which are incorporated by reference herein.

### System Overview

### Hydrocarbon Site

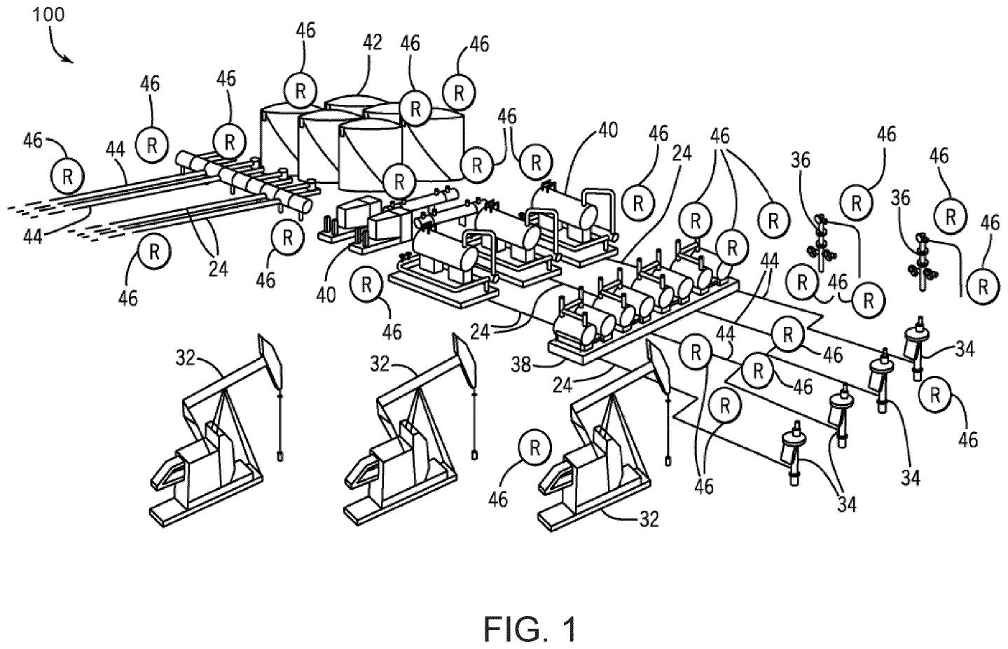

Referring now to FIG. 1, a hydrocarbon site 100 may be an area in which hydrocarbons, such as crude oil and natural gas, may be extracted from the ground, processed, and/or stored. As such, the hydrocarbon site 100 may include a number of wells and a number of well devices that may control the flow of hydrocarbons being extracted from the wells. In one embodiment, the well devices at the hydrocarbon site 100 may include any device equipped to monitor and/or control production of hydrocarbons at a well site. As such, the well devices may include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons may be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 may be connected together via a network of pipelines 44. As such, hydrocarbons extracted from a reservoir may be transported to various locations at the hydrocarbon site 100 via the network of pipelines 44.

The pumpjack 32 may mechanically lift hydrocarbons (e.g., oil) out of a well when a bottom hole pressure of the well is not sufficient to extract the hydrocarbons to the surface. The submersible pump 34 may be an assembly that may be submerged in a hydrocarbon liquid that may be pumped. As such, the submersible pump 34 may include a hermetically sealed motor, such that liquids may not penetrate the seal into the motor. Further, the hermetically sealed motor may push hydrocarbons from underground areas or the reservoir to the surface.

The well trees 36 or christmas trees may be an assembly of valves, spools, and fittings used for natural flowing wells. As such, the well trees 36 may be used for an oil well, gas well, water injection well, water disposal well, gas injection well, condensate well, and the like. The wellhead distribution manifolds 38 may collect the hydrocarbons that may have been extracted by the pumpjacks 32, the submersible pumps 34, and the well trees 36, such that the collected hydrocarbons may be routed to various hydrocarbon processing or storage areas in the hydrocarbon site 100.

The separator 40 may include a pressure vessel that may separate well fluids produced from oil and gas wells into separate gas and liquid components. For example, the separator 40 may separate hydrocarbons extracted by the pumpjacks 32, the submersible pumps 34, or the well trees 36 into oil components, gas components, and water components. After the hydrocarbons have been separated, each separated component may be stored in a particular storage tank 42. The hydrocarbons stored in the storage tanks 42 may be transported via the pipelines 44 to transport vehicles, refineries, and the like.

The well devices may also include monitoring systems that may be placed at various locations in the hydrocarbon site 100 to monitor or provide information related to certain aspects of the hydrocarbon site 100. As such, the monitoring system may be a controller, a remote terminal unit (RTU), or any computing device that may include communication abilities, processing abilities, and the like. For discussion purposes, the monitoring system will be embodied as the RTU 46 throughout the present disclosure. However, it should be understood that the RTU 46 may be any component capable of monitoring and/or controlling various components at the hydrocarbon site 100. The RTU 46 may include sensors or may be coupled to various sensors that may monitor various properties associated with a component at the hydrocarbon site 10.

The RTU 46 may then analyze the various properties associated with the component and may control various operational parameters of the component. For example, the RTU 46 may measure a pressure or a differential pressure of a well or a component (e.g., storage tank 42) in the hydrocarbon site 100. The RTU 46 may also measure a temperature of contents stored inside a component in the hydrocarbon site 100, an amount of hydrocarbons being processed or extracted by components in the hydrocarbon site 100, and the like. The RTU 46 may also measure a level or amount of hydrocarbons stored in a component, such as the storage tank 42. In certain embodiments, the RTU 46 may be iSens-GP Pressure Transmitter, iSens-DP Differential Pressure Transmitter, iSens-MV Multivariable Transmitter, iSens-T2 Temperature Transmitter, iSens-L Level Transmitter, or Isens-10 Flexible I/O Transmitter manufactured by vMonitor® of Houston, Texas.

In one embodiment, the RTU 46 may include a sensor that may measure pressure, temperature, fill level, flow rates, and the like. The RTU 46 may also include a transmitter, such as a radio wave transmitter, that may transmit data acquired by the sensor via an antenna or the like. The sensor in the RTU 46 may be wireless sensors that may be capable of receive and sending data signals between RTUs 26. To power the sensors and the transmitters, the RTU 46 may include a battery or may be coupled to a continuous power supply. Since the RTU 46 may be installed in harsh outdoor and/or explosion-hazardous environments, the RTU 46 may be enclosed in an explosion-proof container that may meet certain standards established by the National Electrical Manufacturer Association (NEMA) and the like, such as a NEMA 4X container, a NEMA 7X container, and the like.

The RTU 46 may transmit data acquired by the sensor or data processed by a processor to other monitoring systems, a router device, a supervisory control and data acquisition (SCADA) device, or the like. As such, the RTU 46 may enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 may receive real-time or near real-time data associated with a well device. The data may include, for example, tubing head pressure, tubing head temperature, case head pressure, flowline pressure, wellhead pressure, wellhead temperature, and the like. In any case, the RTU 46 may analyze the real-time data with respect to static data that may be stored in a memory of the RTU 46. The static data may include a well depth, a tubing length, a tubing size, a choke size, a reservoir pressure, a bottom hole temperature, well test data, fluid properties of the hydrocarbons being extracted, and the like. The RTU 46 may also analyze the real-time data with respect to other data acquired by various types of instruments (e.g., water cut meter, multiphase meter) to determine an inflow performance relationship (IPR) curve, a desired operating point for the wellhead 30, key performance indicators (KPis) associated with the wellhead 30, wellhead performance summary reports, and the like. Although the RTU 46 may be capable of performing the above-referenced analyses, the RTU 46 may not be capable of performing the analyses in a timely manner. Moreover, by just relying on the processor capabilities of the RTU 46, the RTU 46 is limited in the amount and types of analyses that it may perform. Moreover, since the RTU 46 may be limited in size, the data storage abilities may also be limited.

In certain embodiments, the RTU 46 may establish a communication link with the cloud-based computing system 12 described above. As such, the cloud-based computing system 12 may use its larger processing capabilities to analyze data acquired by multiple RTUs 26. Moreover, the cloud-based computing system 12 may access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

### Site Control System

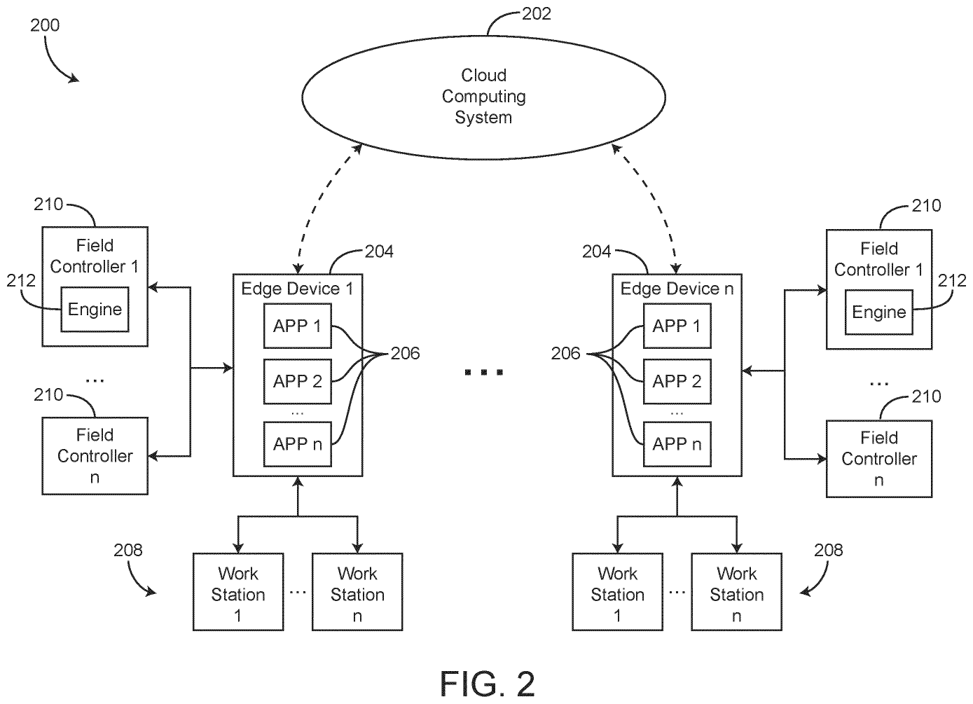

Referring particularly to FIG. 2, a control system 200 (e.g., a network) for hydrocarbon site 100 is shown, according to some embodiments. In some embodiments, control system 200 includes or is configured to communicate with cloud computing system 202 and is configured to control various operations of a well site (e.g., hydrocarbon site 100) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuitry, processors, memory, etc., or combination thereof within cloud computing system 202 may be performed by various devices disclosed within control system 200. Control system 200 is further shown to include edge devices 204, workstations 208, and field controllers 210.

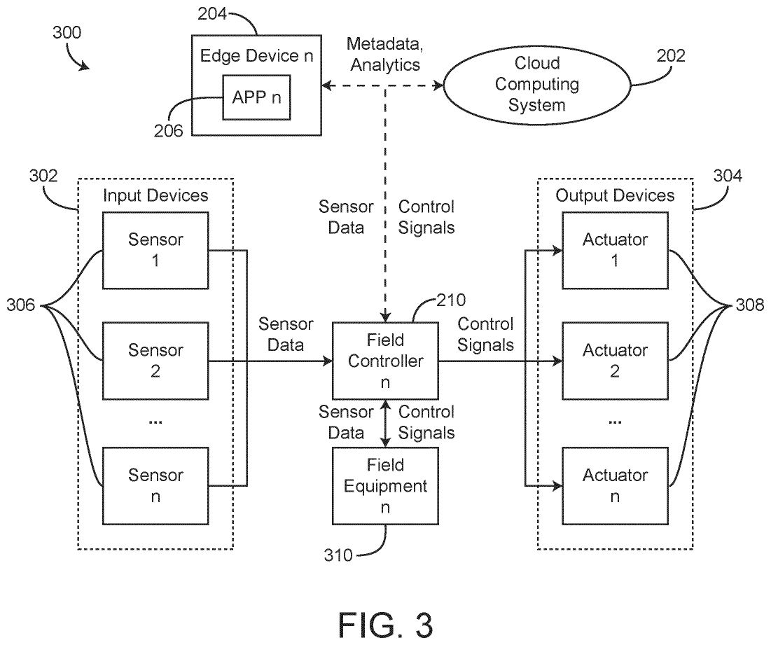

Edge devices 204 may be configured to run, perform, implement, store, etc., one or more applications 206 thereof. Additionally, some or all processing circuitry, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

Field controllers 210 may be configured to control various operations at a well site and are communicably coupled with edge devices 204. In some embodiments, field controllers 210 are configured to operate (e.g., provide control signals to, provide setpoints to, adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), control signals, storage data, maintenance data, setpoint adjustments, operational adjustments, diagnostic data, analytics data, meta data, etc., with field controllers 210. It should be understood that each edge device 204 can be associated with, corresponding to, etc., multiple field controllers 210. In some embodiments, the meta data may include a description of the equipment or name of the equipment, a communication identification, a port identification, unit value identification, range identification, type of signal (e.g., analog or digital), hierarchy of the data, identification of data or sensors redundant to the data or sensor providing the data, etc.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210, or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., any n number of workstations 208) are associated with each edge device 204, while in other embodiments, one or more of edge devices 204 are associated with a single workstation 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Field Controller

Referring now to FIG. 3, control system 200 for performing control of output devices 304 based on input devices 302 is shown, according to exemplary embodiments. Control system 200 is shown to include edge device 204 including application 206, cloud computing system 202, field controller 210, field equipment 310, input devices 302, and output devices 304.

Input devices 302 may be configured to provide various sensor data and/or field measurements from hydrocarbon site 100 to field controller 210 for processing. For example, Sensor 306 of input devices 302 is measuring the pump speed of pump 34. Sensor 306 provides the pump speed of pump 34 to field controller 210 at regular intervals (e.g., continuously, ever minute, every 5 minutes, etc.). Input devices 302 may be connected wired or wirelessly to field controller 210 or any other device within system 200 (e.g., edge device 204). In some embodiments, input devices 302 are coupled to various site equipment (e.g., pumps, pumpjacks, cranes, etc.) and provide operational data of their respective site equipment to field controller 210.

Output devices 304 may be configured to receive control signals from field controller 210 and adjust operation based on the received control signals. For example, field controller 210 determines that pump 34 is operating at a lower pump speed than is considered optimal. Field controller 210 subsequently sends a control signal to an output device (e.g., actuator) 304 to increase pump speed for pump 34. In some embodiments, output devices 304 are configured to act as any device (e.g., actuator, etc.) capable of adjusting operation of site equipment within hydrocarbon site 100. In some embodiments, various other field equipment (e.g., field equipment 310) include some or all of the functionality of input devices 302 and output devices 304 and provide sensor data and receive control signals from field controller 210.

In some embodiments, control system 200 is configured to analyze various sets of data (e.g., metadata) to determine control schema that is optimal for hydrocarbon site 100. A significant amount of processing for this may be performed by edge devices (e.g., edge device 204), instead of processing all metadata analytics in the cloud, as processing the data in on-site or proximate edge devices can decrease latency compared to sending the data to cloud computing system 202 for processing. For example, sensors 306 provide metadata to field controller 210. Field controller 210 processes the data to determine the type of data and/or domain from which the data is received and provides the data to edge device 204 for analytics. An application within edge device 204 (e.g., application 206) may analyze the metadata to make decisions about the control schema that would have been otherwise unnoticed by processing within control system 200. For example, application 206 may infer that the data received has been received by a flow meter sensor (e.g., sensor (1) 306), based on the patterns seen in the data and a priori data that edge device 204 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 306 and sensor (2) 306 may be flow sensors, but from different vendors. As such, sensor (1) 306 may provide data to field controller 210 in a different format than sensor (2) 306. However, application 206 of edge device 204 may still be able to standardize the data and determine that both sets of data are from flow sensors, despite the received data being in different formats (e.g., one data set is provided under resource description framework (RDF) specifications, one data set is provided as data objects, etc.). In various embodiments, allowing edge device 204 to perform some or all of the metadata analytics allows for improved data analytics and control schema without significantly increasing processing latency.

### Model Based Control and Artificial Intelligence Agents

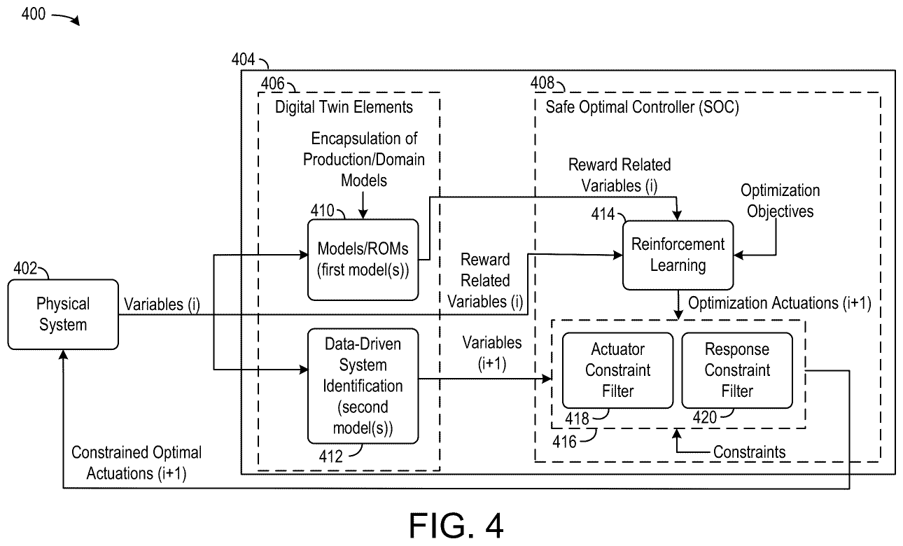

Referring now to FIG. 4, a block diagram of a system 400 for providing optimal control of a physical system is shown, according to some embodiments. The system can be provided via programming instructions stored on one more non-transitory readable media and one or more processors operable to executing such programming instructions to perform the operations described herein and provide the models, system identification, predictions, reinforcement learning, constraint filters, etc. shown in FIG. 4 and described herein. The system can be provided on hardware at the edge (e.g., provided as part of, physically coupled to, and/or in geographic proximity to actuators, sensors, and/or the physical system), via remote computing resources (e.g., cloud resources, remote servers, geographically away from one or more actuators, sensors, and/or the physical system, etc.) for example communicable via the Internet or other network with one or more actuators, sensors, and/or the physical system, and/or distributed across any combination of such computing devices. For example, the elements of FIG. 4 may be provided by, on, as part of, etc. any of the field controller n 21, filed equipment n 310, cloud computing system 202, and edge device n 204 of FIG. 3, or a combination thereof.

FIG. 4 is shown as including a physical system 402. The physical system 402 is a dynamic environment that includes one or more actuators. Operation of the one or more actuators affects one or more states of the system (e.g., measurable conditions, measured and/or unmeasured variables, etc. such as temperature, pressure, speed, frequency, position, flow rate, resource consumption, electricity usage, etc.). The one or more actuators can include one or more pumps, motors, valves (e.g., electrical actuators operable to provide opening and closing valves), power electronics, variable frequency drives, or other equipment or devices operable to physically affect dynamics of the physical system 402. The physical system 402 of FIG. 4 can include one or more sensors that measure one or more variables (v(i) (denoting values of the variables at time step i)) representing one or more states of the physical system 402. In some embodiments, the physical system 402 is a hydrocarbon system. In various embodiments, the physical system is the hydrocarbon site 100 or any element or collection of elements of the site 100.

FIG. 4 shows a control system 404 including digital twin elements 406 and a safe optimal controller (SOC) 408. The digital twin elements 406 can be implemented using teachings of U.S. Patent Application Publication No. 2022-0180019, filed Dec. 7, 2021, the entire disclosure of which is incorporated by reference herein in its entirety.

The digital twin elements 406 are shown as including one or more first models (Models/ROMs) 410 and one or more second models (Data-Driven System Identification) 412. The one or more first models 410 is configured to estimate an estimated value of a state or condition of the physical system, for example a state or condition of the physical system which is not or cannot be directly measured (e.g., due to absence of certain sensors, due to an inherently unmeasurable character of the state or condition, due to dataflow or network limitations). The estimated value can be a reward-related variable and can be denoted r(i) to represent a value of the reward-related variable r at time i. The estimated value can be generated by the one or more first models based on at least a subset of the measured variables v(i). The estimated value can be referred to as a virtual point, a virtual variable, a synthetic variable, etc. in various embodiments.

The one or more first models 410 can be any type of model, for example a reduced-order model (ROM). In some embodiments, the one or more first models 410 can be or include a digital twin of the physical system, for example as in U.S. Patent Application Publication No. 2022-0180019, filed Dec. 7, 2021, the entire disclosure of which is incorporated by reference herein in its entirety. In some embodiments, the one or more first models 410 include physics-based first-principles models (equations, simulations, etc.), for example adapted to calculate a value of an unmeasured variable that will occur given a value of a measured variable v(i). In some embodiments, the one or more first models 410 are general/scalable in nature, such that the one or more first models need not necessarily be adapted, retrained, reconfigured, etc. for different deployments but can be easily and efficiently deployed in different instances and for different physical systems.

The one or more second models 412 are configured to predict future values of one or more variables of the physical system. As shown in FIG. 4, the one or more second models 412 make a one-time-step ahead prediction of v(i+1) (value of v at time step i+1) based on the measured value of v(i). In other embodiments, a multi-step ahead prediction horizon is used. However, it can be advantageous for the one or more second models 412 to focus on single-step ahead predictions for purposes of ensuring compliance with constraints at relatively-low computational complexity, as discussed in further detail below.

The one or more second models 412 are shown as being generated using data-driven system identification. Historical and/or simulated (synthetic) data relating to operation of the physical system can be used to fit (train, identify) parameters, weights, etc. of the one or second model 412 to provide data-driven system identification of the one or more second models 412. In some embodiments, the one or more second models 412 include a gray-box model having a structure based on physical principles of the physical system and parameters identified via data-driven system identification. In some embodiments, the one or more second models 412 include a neural network (e.g., a recurrent neural network, long-short-term-memory), a generative pre-trained transformer (e.g., large language model), or other artificial intelligence model configured to handle timeseries data. The one or more second models 412 can be automatically re-trained over time as more data becomes available relating to physical system dynamics (e.g., more measurements of v), for example such that the one or more second models 412 are automatically adapted as dynamics of the physical system change over time. In some embodiments, the one or more second models 412 include multiple models which are selected between based on characteristics of input data (e.g., based on a location of the measured variable in a modeling space) with different models performing better for different input data.

As shown in FIG. 4, the system also includes a safe optimal controller (SOC) 408. The SOC is shown as including a reinforcement learning model 414 and a constraint engine 416. The reinforcement learning model 414 is shown as receiving values of the variable v(i) and the estimated (virtual, synthetic, etc.) variable (r(i)). The reinforcement learning model 414 can use the values of the measured variable and/or the estimated variable to calculate a reward, for example using a reward function. For example, the reward function can output a numerical value reflecting a degree to which the current values of a measured variable and/or the estimated variable reflect achievement of a goal for the physical system. The reinforcement learning model can then both (1) generate an optimistic actuation (oa(i+1)) for one or more actuator(s) of the physical system predicted to improve the reward (drive the system toward a goal) and (2) self-retrain to improve its own ability to cause the system to provide better (e.g., higher, lower) values of the reward function. The reinforcement learning model 414 can be a neural network or other artificial intelligence model and can use a proximal policy optimization or policy gradient-based learning approach to improve its outputs over time and to adapt to changing system dynamics.

The output of the reinforcement learning model 414 is shown as an optimistic actuation (oa(i+1)). The output is referred to as optimistic, as it is a best-case actuation (e.g., setting, control signal, command, setpoint, target position, on/off decision, etc.) for one or more actuators of the physical system before consideration of constraints on the actuations or the physical system as applied by the constraint engine 416 and discussed below. The reinforcement learning model 414 as shown is structured, trained, operated, etc. without direct (explicit, etc.) inclusion of constraints, including (in some embodiments) in the reward function used by the reinforcement learning model 414 (i.e., such that the reinforcement learning model 414 is agnostic of, independent of, etc. any constraints). The reinforcement learning model 414 can thus be structurally simpler and more efficient to build (e.g., as a same structure can be used regardless of physical constraints), train (e.g., trainable on less data), and execute (e.g., due to relative model simplicity) as compared to approaches in which an optimization problem or model is formulated with constraints included directly therein (e.g., as a large system of equations that can include difficult-to-handle nonlinearities and the like).

The optimistic actuation (oa(i+1)) output from the reinforcement learning model 414 is provided as an input to a constraint engine 416 which is shown as including an actuator constraint filter 418 and a response constraint filter 420. The actuator constraint filter 418 can apply constraints relating to physical limits on operation of the actuator (e.g., maximum or minimum actuator capacity, frequency, speed, etc., positional limits of the actuator, etc.) to ensure that actuations provided by the control system 404 are capable of being met by the actuators (e.g., actuators 308 which may be included in physical system 402) within the operational limits of the actuators.

The response constraint filter 420 can apply constraints relating to limits on the physical response of the physical system 402, for example limits on values of the variable v(i) or r(i). The limits can be desired bounds (e.g., a preferable operating range) or critical limits, for example limits outside of which damage or other adverse consequence is expected to occur to the physical system 402. Accordingly, continuous compliance with such limits can be critical to proper system operation and can be achieved by the implementation illustrated in FIG. 4.

In the system of FIG. 4. the actuator constraint filter 418 and the response constraint filter 420 take the optimistic actuation (oa(i+1)) from the reinforcement learning model 414 as an input and output a constrained optimal actuation (ca(i+1) (with “constrained” referring to guaranteed compliance with constraints applied by the actuator constraint filter 418 and the response constraint filter 420). The actuator constraint filter and the response constraint filter can be implanted using control barrier functions and/or quadratic programming, for example to find the constrained optimal actuation (ca(i+1)) which tracks the optimistic actuation (oa(i+1)) as closely as possible while ensuring compliance with the actuator constraints and response constraints. The actuator constraint filter 418 and/or the response constraint filter 420 can use the predictions of v(i+1) from the one or more second models in determining the constrained optimal actuation (ca(i+1)), for example for determining that the constrained optimal actuation (ca(i+1)) will provide for compliance with constraints at time step i+1 given the predicted value v(i+1).

Advantageously, the approach of the safe optimal controller 408 (with “safe” or “safety” herein referring to substantially-guaranteed compliance with the actuator and/or response constraints) in FIG. 4 ensures compliance with constraints whereas other approaches (e.g., where constraints are applied as penalties in a reward function of the reinforcement learning model) may merely penalize non-compliance and occasionally cause non-compliant conditions to occur. Accordingly, the teachings herein are well-adapted for scenarios where compliance with constraints is critical to operation of a physical system without damaging equipment or causing other significant adverse consequences while providing for an easily-trainable, self-improving reinforcement learning model to optimize operations.

The constrained optimal actuation (ca(i+1)) is shown as being provided from the constraint engine 416 to the physical system 402. One or more actuators (e.g., actuators 308) of the physical system 402 are caused to operate in accordance with the constrained optimal actuation (ca(i+1)) during time step (i+1). The physical system 402 will evolve dynamically during time step i+1, such that values of states, variables, etc. (e.g., v) changes during time step i+1. The control approach of FIG. 4 can then be executed again at the subsequent time step, repeatedly, such that iterations of the process described above are executed over time to provide optimized operation of the physical system 402 in a manner complaint with constraints.

As the system 400 operates iteratively over time, the reinforcement learning model 414 will be updated based on physical system dynamics resulting from the constrained optimal actuations constrained optimal actuation (ca(i+1)). Accordingly, the reinforcement learning model 414 may adapt over time in a manner that implicitly accounts for adjustments being made by the constraint engine 416 to the optimistic actuations oa(i+1), thereby minimizing any suboptimality that may be caused by operation of the constraint engine 416 in ensuring compliance with constraints. The one or more first models 410 and the one or more second models 412 can also be updated based on data generated via such iterations. A complex control system including interrelated models and constraint filters which self-improves both modularly and as a whole can thereby be provided which provides, with computational efficiency, optimized operation of the physical system 402 while ensuring compliance with constraints on the physical system 402.

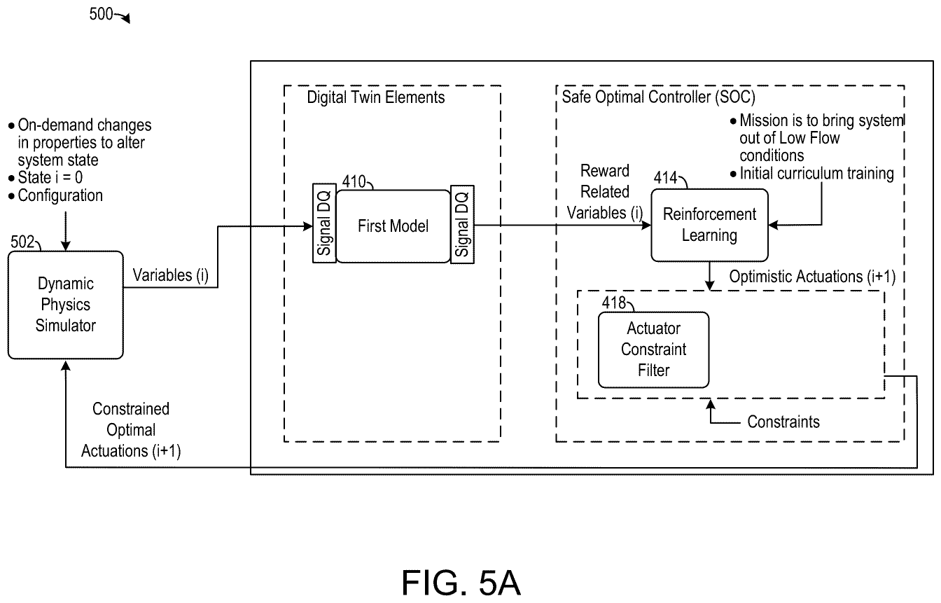

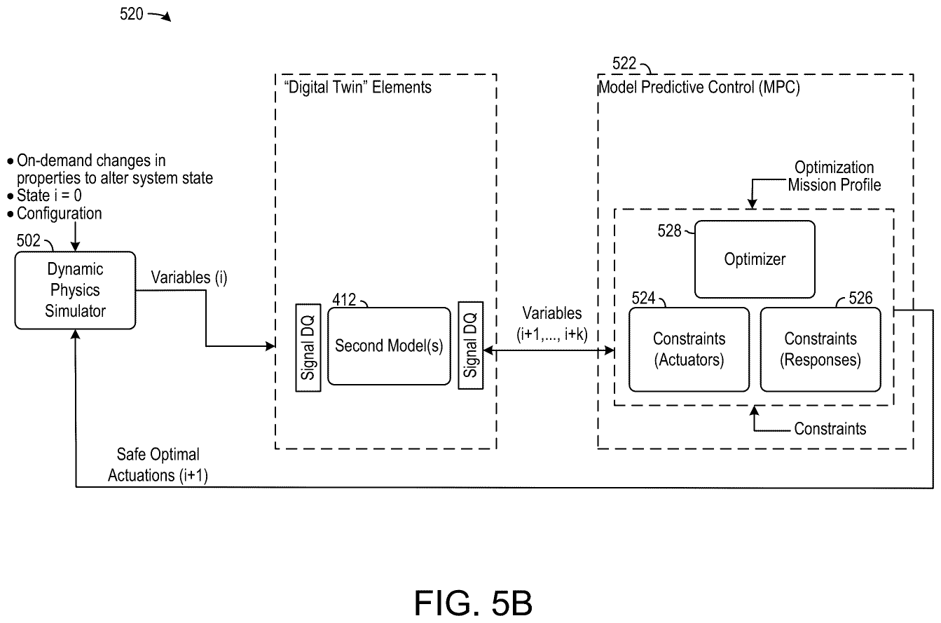

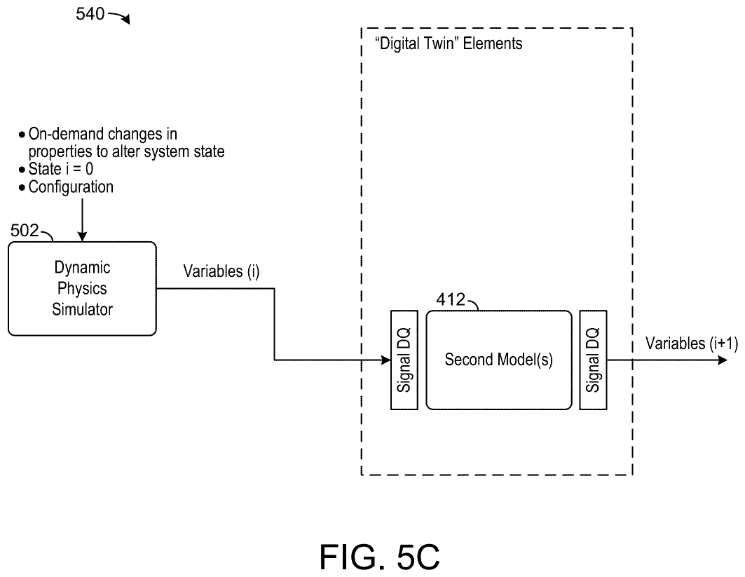

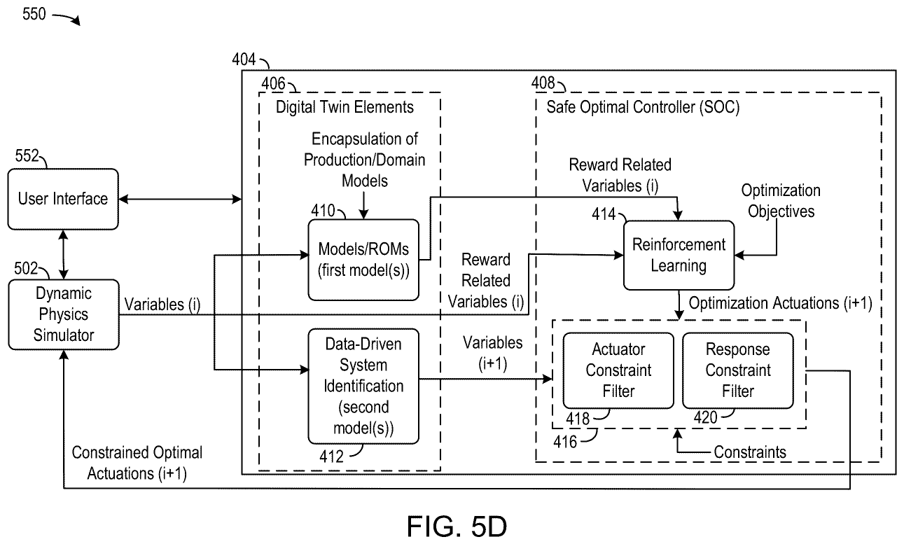

Referring now to FIGS. 5A-D, a variety of combinations of the elements shown in FIG. 4 are shown, according to some embodiments. FIGS. 5A-D illustrate that different combinations of (including omissions of) the one or more first models, one or more second models, reinforcement learning model, actuator constraint filter, and/or response constraint filter can be provided in various embodiments.

FIG. 5A includes an illustration of a system 500 including a physics simulator 502 providing a simulation of the physical system 402, a first model 410 for estimating a reward related variable based on a measured variable (e.g., as simulated by the physics simulator 52), the reinforcement learning model 414, and the actuator constraint filter 418. In the example shown in FIG. 5A, other elements of FIG. 4 are omitted. Such an embodiment can be used for training of the reinforcement learning model 414, for example using a physics simulator 502 for initial training before deploying the reinforcement learning model 414 for online control. Accordingly, the physics simulator 502 as shown in FIGS. 5A-D can be replaced by a real, physical system (e.g., a hydrocarbon system as in FIG. 1, physical system 402), for example including at least one actuator and/or at least one sensor, for example for use of the teachings herein for use in active online control and/or for operation on real-world data. The first model 410 can be provided as an automatic event detection model. As shown, the reinforcement learning model 414 can use, as inputs, a mission and initial training state for the reinforcement learning model 414 and the system 500. For example, as shown, the reinforcement learning model 414 receives an input (e.g., user input) indicating that a mission for the system 400 is to bring the system out of low flow conditions. The user input can use such input to provide a reward relationship that provides optimistic actuations oa(i+1) to achieve that mission.

FIG. 5B includes an illustration of a system 520 including the dynamic physics simulator 502 providing a simulation of the physical system 402 (or the physical system 402 itself, in various embodiments), one or more second models 412 that use a current value of a variable from the dynamic physics simulator 502 to provide predictions (e.g., multi-step-ahead predictions), and a model predictive controller 522 which includes actuator constraints 524 and response constraints 526 as integral parts of an optimization executed by an optimizer 528 to directly output constrained optimal actuations based on the predictions from the one or more second models 412. The one or more second models 412 can included one or more forward system identification models. The system 520 can thereby provide model predictive control of the physical system 402 and/or a simulation thereof, with the model predictive controller 522 operating to cause the physical system 402 (or the simulator 502) to operate in accordance with optimal actuations determined to minimize an objective (cost, etc.) (e.g., or maximize an optimization mission profile) subject to the actuator constraints 524 and the response constraints 526.

FIG. 5C shows an illustration of a what-if simulator 540, where the what-if simulator includes the physics simulator 502 (providing a simulation of the physical system) and the one or more second models 412 (e.g., forward system identification model(s)) for predicting future values of one or more variables based on a current value or history of values provided by the physics simulator 502. Such an embodiment can deploy the teachings above for using in simulation, predicting future states, etc. according to various embodiments. The what-if simulator 540 can receive user inputs of an initial state, physical system configuration, and/or on-demand changes in properties of the system, and is configured to output a prediction of one or more future values of one or more variables. The output of the what-if simulator 540 can be displayed on a graphical user interface, otherwise communicated to a user, or used in further analytics and/or control operations.

FIG. 5D shows an illustration of a system 550 which is consistent with FIG. 4, but including a dynamic physics simulator 502 in place of the physical system 402 and also further including a user interface 552. Such an embodiment can be used offline for generating data to train and validate the various models and the combination thereof, for example to initialize model training before sufficient historical data is available for a particular physical system. Such an embodiments can also be used for generating simulation data that can facilitate designing a physical system, determining whether to invest in a physical system, etc. The user interface 552 can included a graphical user interface displayed on a personal computing device (e.g., desktop computer, laptop, tablet, smartphone, augmented- or virtual-reality headset) and can display results of such simulations by the system 550 to the user and allow the user to provide inputs relating to configuration of the physical system (e.g., equipment included, sensors included, size, physical arrangement, etc.), settings or conditions to consider (e.g., well conditions, geological influences, etc.) within the dynamic physics simulator 502 and/or to tune aspects of the digital twin elements 406 and/or the safe optimal controller 408 (e.g., to adjust optimization objectives, modify a reward function, adjust actuator or response constraints, etc.). The system 550 can thereby provide a user with the ability to set up, adjust, and cause the system 550 to run simulations in accordance with user inputs and selections. In some embodiments, the user interface 552 includes an artificial intelligence agent configured to orchestrate operations of the dynamic physics simulator 502 and/or the control system 404 in accordance with user queries and requests.

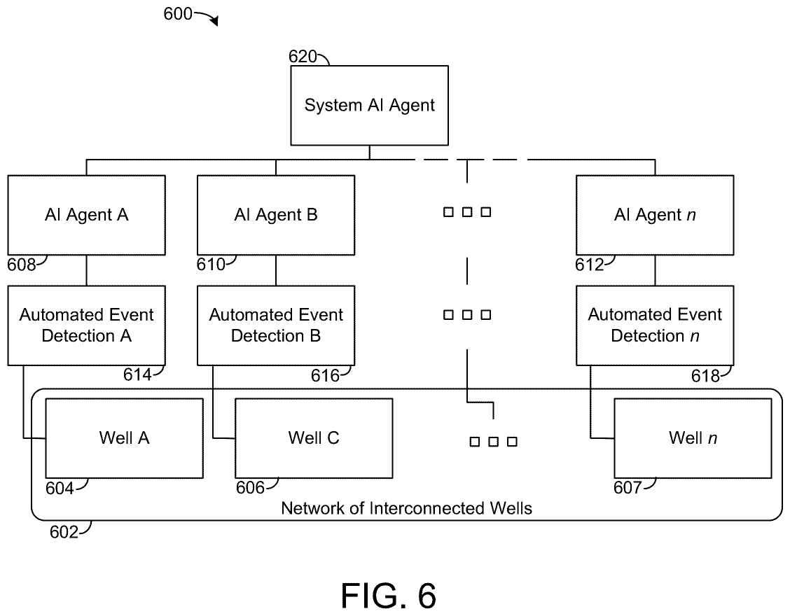

Referring now to FIG. 6, a system architecture 600 is shown, according to some embodiments. The system is shown as including a network of interconnected wells 602, including any number of wells (shown as well A 604, well B 606, through well n 607). The network of interconnected wells 602 can be fluidically connected, for example geologically (e.g., underground) and/or by fluidic connections in pipes, equipment, etc. receiving outputs of the wells 602. As shown in FIG. 6, each well in the network of interconnected wells is served by an artificial intelligence agent (shown as AI Agent A 608, AI Agent B 610, through AI Agend n 612) and an automated event detection (AED) tool (shown as automated event detection A 614, automated event detection B 616, through automated event detection n 618). A system-level artificial intelligence agent 620 coordinates and managements the multiple well-associated artificial intelligence agents 608, 610, 612. The automated event detection tools 614, 616, 618 can be configured to automatically detect events occurring in their corresponding wells 604, 606, 607, for example using a rules-based or model-based event detection technique. Such event information can then be used by the corresponding AI agents 608, 610, 612 to make operational decisions with respect to the corresponding well 604, 606, 607, with the system AI agent 620 providing supervisory coordination of the AI agents 608, 610, 612. The system AI agent 620 can interoperate with the AI agents 608, 610, 612 to react and interact to resolve (or minimize) as many event severities as possible while optimizing a reward function, in some embodiments. FIG. 6 thereby illustrates how various teachings herein can be implemented in an artificial-intelligence-enabled network and in a distributed manner to provide for a scalable system with multiple levels of intelligence to provide, for example, autonomous operation of the network of interconnected wells.

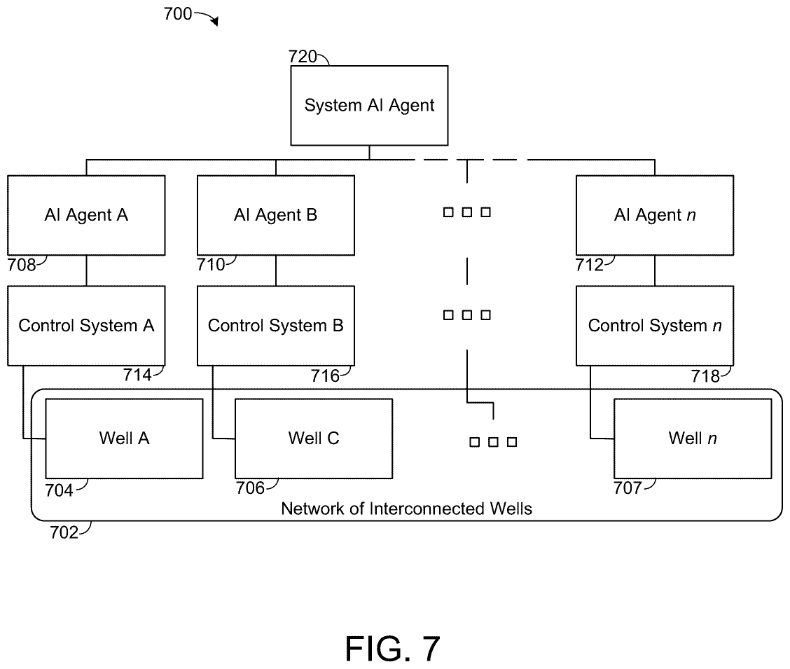

Referring now to FIG. 7, a system architecture 700 is shown, according to some embodiments. The system is shown as including a network of interconnected wells 702, including any number of wells (shown as well A 704, well B 706, through well n 707). The network of interconnected wells 702 can be fluidically connected, for example geologically (e.g., underground) and/or by fluidic connections in pipes, equipment, etc. receiving outputs of the wells 702. As shown in FIG. 7, each well in the network of interconnected wells 702 is served by a control system (shown as control system A 714, control system B 716, through control system n 717) which can be implemented as instances of the control system 404 of FIG. 4, for example including a reinforcement learning model, constraint filters (e.g., actuator constraint filter, response constraint filter as described above), digital twin elements such as one or more first models as described above and/or second models (e.g., a system identification model). The control systems receive measurements or other data from, and control, the corresponding wells (e.g., control system A 714 controls equipment of well A 704, control system B 716 controls equipment of well B, control system n 718 controls of equipment of well n). Each well also has an associated AI agent, shown as AI agent A 708, AI agents B 710, through AI Agent n 712 which can provide autonomous orchestration of the operation of the corresponding control systems; accordingly each AI agent can control each corresponding well by executing the operations of the corresponding control systems (e.g., by implementing the features described in detail above with reference to FIG. 4). A system-level AI agent 720 is also provided and shown as providing supervisory control for the multiple AI agents 708, 710, 712 associated with the different wells of the network of interconnected wells 702. In some embodiments, for example, the system-level AI agent 720 can provided adjusted constraints and/or reward functions to the multiple AI agents 708, 710, 712 for use by the control systems 714, 716, 718 to coordinate operations of the network of interconnected wells 702, for example such that a change in one well which affects the network of interconnected wells 702 can be proactively handled by the system of AI agents.

In some embodiments, the system-level AI agent 720 orchestrates the operations of the multiple AI agents 708, 710, 712 by causing the reward function, constraint(s), and/or prediction used according to the teachings above for a first well (e.g., well A 704) to be based on one or more variables associated with the first well (e.g., representing conditions, performance, etc. of well A 704) and further based on one or more additional variables associated with one or more additional wells (e.g., variables representing conditions, performance, etc. of well B 706 through well n 707). For example, a reward function and/or a constraint can be based on a sum, difference, product, or ratio of a variable for well A 704 and an additional variable for well B 706 (e.g., a sum of power consumption values, a sum of flow rates, a ratio of pump rates, a difference in temperatures, etc.). As another example, a prediction of a future value for a first well A 704 can be based on data for well B 706, thereby accounting for physical affects of well B 706 on well A 704. Various such interrelationships between interconnected wells can thus be handled by various implementations of the teachings herein.

FIG. 7 thus illustrates the scalability and adaptability of the systems and methods disclosed herein.

In some aspects, the present disclosure relates to one or more non-transitory computer-readable media storing program instructions that, when executed by one or more processors, cause the one or more processors to perform operations including providing an artificial intelligence agent. The artificial intelligence agent can include a first model configured to estimate an estimated value of a second variable at the current time step based on a measured value of a first variable, a second model configured to predict a predicted value of the first variable for a subsequent time step, a reinforcement learning model configured to output a control decision for the subsequent time step based on the measured value of the first variable and the estimated value of the second variable, a constraint engine configured to adjust the control decision based on the predicted value of the first variable to ensure compliance of a system with a constraint at the subsequent time step, and a control engine configured to operate the system using the adjusted control decision.

In some aspects, the present disclosure relates to one or more non-transitory computer-readable media storing program instructions that, when executed by one or more processors, cause the one or more processors to perform operations including providing an artificial intelligence agent. The artificial intelligence agent can include a predictive model configured to predict a predicted value of a first variable for a subsequent time step, a reinforcement learning model configured to output a control decision for the subsequent time step based on a measured value of the first variable, a constraint engine configured to adjust the control decision based on the predicted value of the first variable to ensure compliance with a constraint at the subsequent time step, and a control engine configured to operate a physical system using the adjusted control decision.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method executable by one or more processors, comprising:
generating, by a reinforcement learning model, a control decision for a subsequent time step based on a measured or estimated value of a variable for a current time step;
predicting, with a model, a predicted value of the variable for the subsequent time step based on the measured or estimated value of the variable for the current time step;
adjusting the control decision for the subsequent time step based on a constraint and the predicted value of the variable; and
controlling an actuator based on the control decision.

2. The method of claim 1, wherein the model is a data driven model generated using system identification.

3. The method of claim 1, comprising estimating the estimated value using a digital twin.

4. The method of claim 1, comprising estimating the estimated value using a reduced-order model.

5. The method of claim 1, further comprising training the reinforcement learning model to optimize a reward function comprising the variable and an additional variable, wherein the second variable is a function of the first variable;
wherein generating, by the reinforcement learning model, the control decision comprises predicting, by the reinforcement learning model, that the control decision will result in an optimal value of the reward function.

6. The method of claim 1, wherein the constraint comprises a limit of the actuator and adjusting the control decision comprises moving the control decision into compliance with the limit of the actuator.

7. The method of claim 1, wherein the constraint comprises a limit on a physical condition affected by operation of the actuator.

8. The method of claim 7, wherein violation of the limit causes physical damage.

9. The method of claim 1, further comprising determining the constraint dynamically based on data from an artificial intelligence agent.

10. A system, comprising:
a plurality of interconnected wells;
a plurality of artificial intelligence agents associated with the plurality of interconnected wells;
wherein at least one of the plurality of artificial intelligence agents is configured to control at least one actuator for at least one well of the plurality of interconnected wells by:
generating, by a reinforcement learning model, a control decision for a subsequent time step based on a measured or estimated value of a variable for a current time step;
predicting a predicted value of the variable for the subsequent time step based on the measured or estimated value of the variable for the current time step;
adjusting the control decision for the subsequent time step based on a constraint and the predicted value of the variable; and
controlling the at least one actuator in accordance with the control decision.

11. The system of claim 10, further comprising a supervisory artificial intelligence agent configured to coordinate operations of the plurality of artificial intelligence agents by causing the constraint to be a function of both the variable and an additional variable, wherein the variable is associated with a first well of the plurality of interconnected wells and the additional variable is associated with a second well of the plurality of interconnected wells.

12. The system of claim 10, wherein predicting the predicted value comprises using data from at least two of the plurality of interconnected wells a data driven model generated using system identification and data from at least two of the plurality of interconnected wells.

13. The system of claim 10, wherein the at least one of the plurality of artificial intelligence agents is configured to estimate the estimated value using a digital twin and data from at least two of the plurality of interconnected wells.

14. The system of claim 10, wherein the at least one of the plurality of artificial intelligence agents is configured to estimate the estimated value using a reduced-order model and data from at least two of the plurality of interconnected wells.

15. The system of claim 10, wherein the at least one of the plurality of artificial intelligence agents is configured to control the at least one actuator for the at least one well of the plurality of interconnected wells by further training the reinforcement learning model to optimize a reward function comprising the variable and an additional variable, wherein the variable is associated with the at least one well and the additional variable is associated with an additional well of the plurality of interconnected wells, wherein generating, by the reinforcement learning model, the control decision comprises predicting, by the reinforcement learning model, that the control decision will result in an optimal value of the reward function.

16. The system of claim 10, wherein the constraint comprises a limit on a physical condition affected by operation of the at least one actuator.

17. The system of claim 16, wherein adjusting the control decision further subsequent time step is further based on an additional constraint, wherein the additional constraint represents an operational limit of the at least one actuator.

18. The system of claim 16, wherein violation of the limit causes physical damage.

19. The system of claim 10, wherein the at least one of the plurality of artificial intelligence agents is configured to automatically determine a value for the constraint.

20. One or more non-transitory computer-readable media storing program instructions that, when executed by one or more processors, cause the one or more processors to perform operations comprising providing an artificial intelligence agent, the artificial intelligence agent comprising:
a first model configured to estimate an estimated value of a second variable at a current time step based on a measured value of a first variable;
a second model configured to predict a predicted value of the first variable for a subsequent time step;
a reinforcement learning model configured to output a control decision for the subsequent time step based on the measured value of the first variable and the estimated value of the second variable;
a constraint engine configured to adjust the control decision based on the predicted value of the first variable to ensure compliance of a system with a constraint at the subsequent time step; and
a control engine configured to operate the system using the adjusted control decision.
